(19) United States
(12) Patent Application Publication
(10) Pub. No.: US 2025/0371160 A1
(43) Pub. Date: Dec. 4, 2025

(54) SYSTEMS AND METHODS FOR PREDICTING CYBERSECURITY RISK BASED ON ENTITY FIRMOGRAPHICS

(71) Applicant: BitSight Technologies, Inc., Boston, MA (US)

(72) Inventors: James Delaney, Tiburon, CA (US); Xiaofei Yang, Providence, RI (US); Thomas Erhardt Montroy, Cambridge, MA (US)

(21) Appl. No.: 18/678,378

(22) Filed: May 30, 2024

(51) Int. Cl. G06F 21/57

(52) U.S. Cl. CPC G06F 21/577; G06F 2221/034

(57) ABSTRACT

Systems and methods are disclosed for training a model to predict a cybersecurity risk based on entity firmographics. A breach dataset comprising a number of breach indicator values for a number of entities is generated, wherein each respective breach indicator value is (i) mapped to a respective entity of the entities and (ii) an evaluation of at least one of the first security incidents being associated with the respective entity during a time period. A number of aggregated risk feature values for a plurality of geographic locations are determined based on a plurality of second security observations. The aggregated risk feature values are joined to the breach indicator values and firmographic parameter values to form a training dataset. A model is trained using the training dataset to generate a predictive risk assessment for an entity of the entities based on the firmographic parameter values associated with the entity.

### TECHNICAL FIELD

The following disclosure is directed to methods and systems for predicting a cybersecurity risk, more specifically, methods and systems for training a model to generate predictions of cybersecurity risks based on entity firmographics.

### BACKGROUND

Businesses, corporations, organizations, and other ‘entities’ are often the targets of cybersecurity incidents aimed at disrupting business operations, extracting ransom payments, and other nefarious purposes. To provide an assessment of an entity's cybersecurity posture and ability to mitigate such incidents, data (e.g., externally-observable data and/or internally-observable data) indicating characteristics of the entity's computing assets (e.g., devices and networks) and cybersecurity practices can be aggregated and examined. As an example, a cybersecurity risk rating can be generated based on the aggregated data for an entity's cybersecurity characteristics, and ratings for individual risk vectors that contribute to the cybersecurity risk rating can be determined. However, in some instances, little to no data may be available for specific entities for which cybersecurity assessments are desired. Such a lack of data can reduce or eliminate insights into and assessment of an entity's cybersecurity posture, leaving the entity and their third-party affiliate entities that have relationships with the entity without techniques for assessment of the entity's cybersecurity posture. Further, a lack of insight and assessment for an entity's cybersecurity posture can leave the entity vulnerable to cybersecurity incidents.

### SUMMARY

Disclosed herein are systems and methods for training a model to generate predictions of cybersecurity risks for entities based on entity firmographics and using the trained model to generate the predictions. An entity as described herein may include an organization, a company, a group, a school, a government, etc. An entity may be characterized by one or more firmographic parameters, e.g., entity size, entity industry, entity location, etc. In many cases, a risk of a cybersecurity incident for an entity is associated with entity-specific measures of cybersecurity performance as well as the entity's firmographic parameters (e.g., size, industry, and geographic location).

Entities associated with a particular geographic location, such as having a headquarters and/or operations in a particular country, may be more vulnerable to cybersecurity incidents. As an example, the entities may be more vulnerable to cybersecurity incidents based on minimal government supervision of the entities' cybersecurity mitigation practices and/or a lack of enforcement or penalties for cyber criminals that initiate cyber-attacks. Further, a geopolitical climate in a country can fuel an increase in cyber-attacks directed to entities with operations in particular countries.

Entities in certain industries may also have an increased a risk of experiencing cybersecurity incidents. This could be explained in part by variations in approaches regarding cybersecurity risk, expertise in cybersecurity risk mitigation, and investment in information technology (IT) resources spending across different industries. In addition, a relative value of a first industry's data over other second industries' data and/or a relative importance to society of the first industry over the other second industries can cause industry-dependent variations in cyber criminals' desire to target entities of particular industries.

Another contributor to an entity's cybersecurity risk may be a size of an entity (e.g., as defined by parameters such as the entity's number of employees, operating revenue, and/or total assets). Relative to small entities, large entities typically have larger attack surfaces (e.g., numbers of computing assets available for exploit) and may be capable of paying larger ransoms to eliminate cybersecurity incidents, making them more attractive targets to cyber criminals. However, these large entities may also have the ability and resources to invest in better cybersecurity controls that reduce cybersecurity risk. The relationship between an entity's size and the entity's inherent cybersecurity risk may or may not be monotonically increasing based on other firmographic parameters of the entity.

While an entity has little ability to control its firmographic parameters, it is expected that an entity's firmographic parameters can provide an implicit indication of a cybersecurity risk inherently associated with entities sharing a particular size, industry, and geographic location. Further, there instances where data indicative of cybersecurity performance for particular entities is not available, while the entities' firmographic parameters are readily available. In these cases, a measure of a cybersecurity risk associated with a particular combination of firmographic parameters (referred to herein as a “firmographic neighborhood”) can provide valuable insights regarding an entity's inherent cybersecurity risk. However, quantifying the contribution of a categorical feature (e.g., a geographic location such as a country) to a firmographic neighborhood-based assessment of cybersecurity risk can be susceptible to overfitting and other data availability concerns. As one example, overfitting of a model can occur when predictions are desired for one or more levels of categorical features, but little to no training data for such levels of categorical features is available for training of the model. As another example, overfitting of a model can occur when separate parameters are used for each level of the categorical feature, which can introduce a large number of free parameters into the model to be trained.

Thus, there exists a need for a cybersecurity assessment technique and supporting system that enables generation of predictions of cybersecurity risks based on firmographic parameters. Further, there exists a need for techniques for training a model to generate predictions of cybersecurity risks based on firmographic parameters, while avoiding overfitting of the trained model to training data, such as training data associated with particular categorical features (e.g., geographic locations such as countries).

In various aspects, embodiments of the invention feature a computer-implemented method and supporting systems. In one aspect, the subject matter described herein relates to a computer-implemented method for training a model to predict a cybersecurity risk based on entity firmographics. The method can include generating, based on a first security incident dataset including a plurality of first security incidents, a breach dataset including a plurality of breach indicator values for a plurality of entities, where each respective breach indicator value is (i) mapped to a respective entity of the entities and (ii) an evaluation of at least one of the first security incidents being associated with the respective entity during a time period. The method can include joining, based on the entities, the breach indicator values of the breach dataset to a plurality of firmographic parameter values corresponding to the entities. The method can include obtaining a second security observation dataset including a plurality of second security observations associated with a plurality of geographic locations. The method can include determining, based on the second security observation dataset, a plurality of aggregated risk feature values for the geographic locations, where each geographic location is associated with at least one of the aggregated risk feature values. The method can include joining, based on the geographic locations, the aggregated risk feature values to the breach indicator values and the firmographic parameter values to form a training dataset including each of (i) the breach indicator values, (ii) the aggregated risk feature values, and (iii) the firmographic parameter values. The method can include training, using the training dataset, a cybersecurity risk assessment model configured to generate a predictive risk assessment for a first entity of the entities based on a subset of the firmographic parameter values associated with the first entity.

Various embodiments of the method can include one or more of the following features. The method may also include where for each respective first security incident, the first security incident dataset includes (i) a type of the respective first security incident, (ii) a severity level of the respective first security incident, and (iii) a date associated with the respective first security incident. The method may also include where the evaluation of at least one of the first security incidents being associated with the respective entity during the time period includes (i) a first value identifying at least one of the first security incidents as associated with the respective entity during the time period or (ii) a second value identifying none of the first security incidents as associated with the respective entity during the time period. The method may also include where the firmographic parameter values include one or more of: (i) a plurality of geographic location parameter values, (ii) a plurality of size parameter values, and (iii) a plurality of industry parameter values. The method may also include where the second security observations include at least two security observation types. The method may also include where determining the aggregated risk feature values for the geographic locations includes identifying a subset of the second security observations associated with a geographic location of the geographic locations, and determining at least one of the aggregated risk feature values corresponding to the geographic location by normalizing the subset of the second security observations based on the geographic location.

In some embodiments, the method may also include where at least one of the aggregated risk feature values includes a continuous numerical value. The method may also include where training the cybersecurity risk assessment model includes applying a machine learning technique to (i) the breach indicator values, (ii) the aggregated risk feature values, and (iii) the firmographic parameter values. The method may also include where training the cybersecurity risk assessment model includes applying a statistical technique to (i) the breach indicator values, (ii) the aggregated risk feature values, and (iii) the firmographic parameter values. The method may also include generating, by the cybersecurity risk assessment model, the predictive risk assessment for the first entity of the entities based on the subset of the firmographic parameter values associated with the first entity, where the predictive risk assessment is indicative of a future security incident being associated with the first entity during a future time period.

In some embodiments, the method may also include where generating the breach dataset is based on the types, the severity levels, and the dates of the first security incidents. The method may also include where generating the breach dataset includes for at least one of the first security incidents, identifying a second entity of the entities associated with the first security incident, comparing (i) a type of the first security incident to one or more specified types, (ii) a severity level of the first security incident to a threshold severity level, and (iii) a date of the first security incident to the time period, and generating, based on the comparison, a breach indicator value of the breach indicator values, where the breach indicator value is mapped to the second entity. The method may also include where (i) a geographic location parameter value of the geographic location parameter values indicates a geographic location of the geographic locations associated with an entity of the entities, (ii) a size parameter value of the size parameter values indicates a size of the entity, and (iii) an industry parameter value of the industry parameter values indicates an industry associated with the entity. The method may also include where joining the breach indicator values to the firmographic parameter values includes joining a breach indicator value of the breach indicator values to each of (i) a geographic location parameter value of the geographic location parameter values, (ii) a size parameter value of the size parameter values, and (iii) an industry parameter value of the industry parameter values based on the respective entity associated with the breach indicator value. The method may also include where the at least two security observation types comprise at least one of a number and/or a severity of botnet infection instances of a computer system, a number of potentially exploited computing devices, an evaluation of a Secure Sockets Layer (SSL) certificate and/or a Transport Layer Security (TLS) certificate, an evaluation of a Secure Sockets Layer (SSL) configuration and/or a Transport Layer Security (TLS) configuration, and a number and/or a type of service of open ports of a computer network. The method may also include where the machine learning technique includes at least one of (i) a deep neural network binary classification technique and (ii) a gradient boosted decision tree algorithm. The method may also include where the statistical technique includes at least one of (i) a classical logistic regression technique, (ii) a hierarchical mixed-effect logistic regression technique, and (iii) a Bayesian statistical hierarchical technique. The method may also include where the cybersecurity risk assessment model is configured to generate a probability of the future security incident being associated with the first entity during the future time period, where the predictive risk assessment includes the probability. The method may also include where the cybersecurity risk assessment model is configured to generate a categorical assessment of the future security incident being associated with the first entity during the future time period, where the predictive risk assessment includes the categorical assessment. The method may also include where a duration of the time period is equivalent to a duration of the future time period.

Other aspects of the invention comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a flowchart of an exemplary method for training a model to generate predictions of a cybersecurity risk for an entity based on the entity's firmographic parameters;

FIG. 1B is a diagram of the workflow for training a model to generate predictions of a cybersecurity risk for an entity based on the entity's firmographic parameters;

FIG. 2A is a flowchart of an exemplary method for generating a prediction of a cybersecurity risk for an entity using a trained model based on the entity's firmographic parameters;

FIG. 2B is a diagram of the workflow for generating a prediction of a cybersecurity risk for an entity using a trained model based on the entity's firmographic parameters; and

FIG. 3 is a diagram of a training dataset for training a model to generate predictions of a cybersecurity risk for an entity based on the entity's firmographic parameters; and

FIG. 4 is a block diagram of an example computer system that may be used in implementing the technology described herein.

### DETAILED DESCRIPTION

The present disclosure is directed to methods and systems for training a model to generate predictions of cybersecurity risks for entities based on entity firmographics and using the trained model to generate the predictions. As described herein, data used to conventionally assess an entity's cybersecurity posture may be unknown or otherwise unavailable. In such instances, an entity and their third-party affiliates can require other techniques to generate assessments of the entity's cybersecurity risks. Accordingly, techniques are introduced herein to generate and train models to produce assessments of an entity's risk and susceptibility to future cybersecurity incidents based on firmographic parameters of the entity. Further, techniques for producing a training dataset and a testing dataset to avoiding overfitting the trained models are provided to provide accurate, reliable assessments of cybersecurity risks of the entity. Such assessments may include probabilistic assessments of a likelihood that an entity experiences a cybersecurity incident during a future time period. Such probabilistic assessments may be generated by a model trained using historical data for previous cybersecurity incidents experienced by entities over a particular period of time, where the entities have a number of different firmographic parameters (e.g., sizes, industries, and locations).

### Firmographic Parameters of an Entity

In some exemplary methods and systems described herein, entities may be categorized as corresponding to a particular firmographic neighborhood including a number of entities having particular firmographic parameters. Some non-limiting examples of types of firmographic parameters used to categorize an entity can include a size of the entity, an industry of the entity, and geographic location of the entity. In some variations, additional or alternative types of firmographic parameters may be used. Based on an entity's firmographic parameters, a trained model may generate a prediction of a future cybersecurity risk for the entity for a particular period of time. Such a model may be trained using historical data that associates cybersecurity incidents experienced by entities with firmographic parameters corresponding to those entities. In some variations, the trained model may generate a value of a response variable based on input values for firmographic parameters, where the variable is indicative of a probability an entity will experience at least one cybersecurity incident during a future time period (e.g., a 1-year time period).

In some embodiments, a firmographic size parameter value for an entity may indicate a size of the entity and can be defined based on one or more size parameters. Some non-limiting examples of size parameters include a number of individuals (e.g., employees) of the entity, an operating revenue of the entity, a market capitalization of the entity, and total assets (e.g., total monetary assets) of the entity. In some cases, a firmographic size parameter value for an entity may be a combination (e.g., a weighted combination) of two or more size parameters. For example, a firmographic size parameter value may be categorical value determined by an algorithmic combination of each of a number of individuals of the entity, an operating revenue of the entity, a market capitalization of the entity, and total assets the entity. Some examples of the categorical values can include a very small entity, a small entity, a medium-sized entity, a large entity, and a very large entity. The systems and methods described herein may obtain and/or otherwise determine firmographic size parameter values for a number of entities based on the one or more size parameters.

In some embodiments, a firmographic industry parameter value may indicate an industry associated with the entity (e.g., an industry in which the entity operates) and can be defined based on one or more industry codes. Some non-limiting examples of industry codes used to identify an industry associated with an entity can include Standard Industrial Classification (SIC) codes, North American Industry Classification System (NAICS) codes, and Nomenclature des Activités Économiques dans la Communauté Européenne (NACE) codes. The systems and methods described herein may obtain and/or otherwise determine firmographic industry parameter values for a number of entities based on each entity being associated with at least one industry code. For example, a first entity may be associated with an SIC code and an NAICS code, while a second entity may be associated with only an SIC code. In some cases, a firmographic industry parameter value may be defined based on a portion (e.g., prefix) of one or more industry codes. For example, a firmographic industry parameter value for an entity may include both a four-digit NACE code assigned to the entity and a two-digit NACE code formed from a two-digit prefix of the four-digit NACE code assigned to the entity.

In some embodiments, a firmographic location parameter value may indicate a geographic location associated with the entity and can be defined based on one or more location codes. A geographic location associated with the entity may include a geographic location (e.g., region, province, state, and/or country) in which the entity is headquartered and/or conducts operations. A non-limiting example of a location code used to identify a geographic location associated with an entity can include an International Organization for Standardization (ISO) code (e.g., ISO 3166-1, ISO 3166-2, and/or ISO 3166-3 codes). The systems and methods described herein may obtain and/or otherwise determine location codes for a number of entities based on each entity being associated with at least one location code.

The systems and methods described herein above-described firmographic parameters may be joined (e.g., mapped) to entity-level cybersecurity incident data and location-level (e.g., country-level) aggregated risk feature values to form a training dataset used to train a model as described herein.

### Some Embodiments of Training a Model to Generate Cybersecurity Risk Predictions

In some exemplary methods described herein, a model can be trained to generate probabilistic assessments of a likelihood that an entity experiences a cybersecurity incident during a particular time period (e.g., a future time period). To generate a training dataset used for training a model, the methods described herein may perform steps including: (1) obtaining entity-level cybersecurity incident data, (2) joining entity-level firmographic parameters to the entity-level cybersecurity incident data, (3) obtaining computing asset-level cybersecurity incident data and aggregating the computing asset-level cybersecurity incident data for a number of geographic locations to form location-level cybersecurity incident data, (4) determining a number of aggregated risk feature values for each of the geographic locations based on normalizing the aggregated location-level cybersecurity incident data, and (5) joining the aggregated risk feature values to the entity-level cybersecurity incident data and the firmographic parameters based on the geographic locations of the aggregated risk feature values and firmographic parameters to form a training dataset for the model.

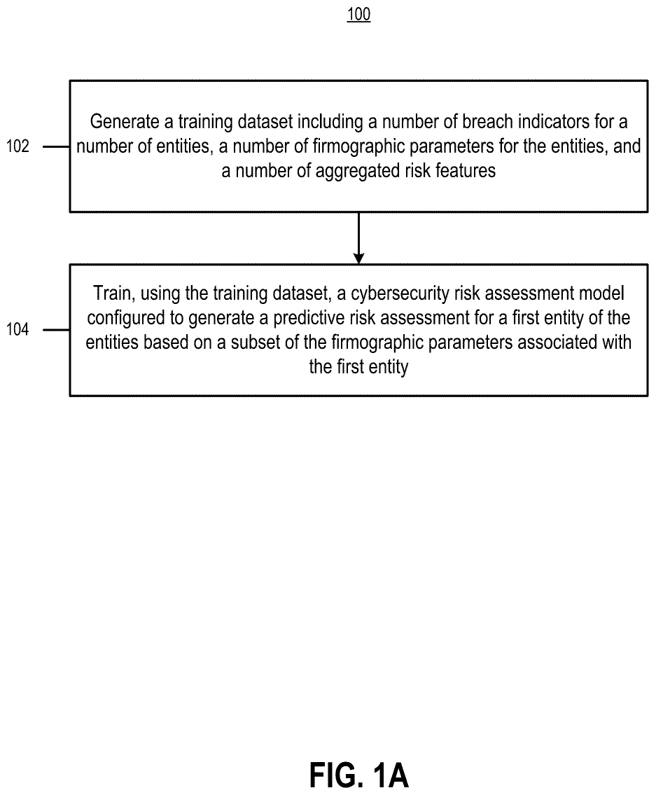

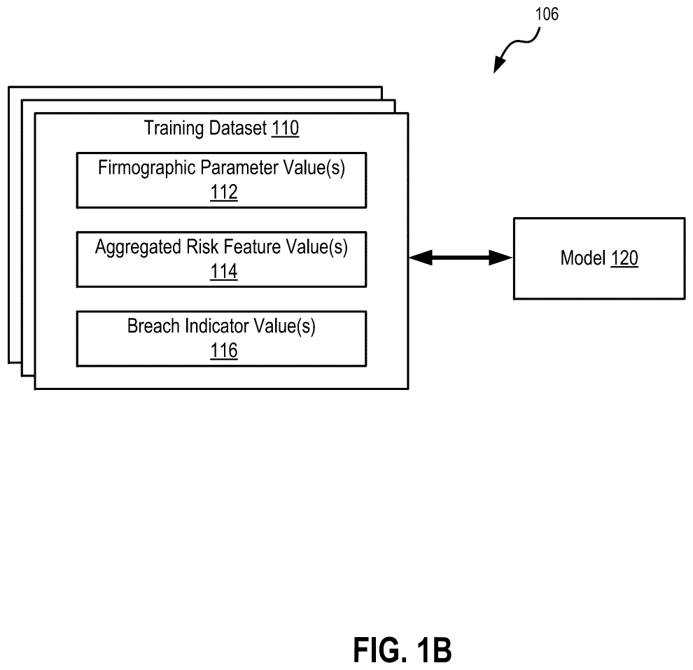

FIG. 1A is a flowchart illustrating a method 100 for training a model to generate predictions of a cybersecurity risk for an entity based on the entity's firmographic parameters. FIG. 1B is a diagram of the workflow 106 for training a model to generate predictions of a cybersecurity risk for an entity based on the entity's firmographic parameters. The predictions may include probabilistic assessments of a likelihood that an entity experiences a cybersecurity incident during a particular time period, such as a future time period. One of ordinary skill in the art will appreciate that the method 100 may be executed more than once to generate multiple models derived from multiple versions of training datasets (e.g., based on updates to the training datasets and/or desirable outputs provided by the models). For example, the method 100 may be re-executed to generate models configured to provide probabilistic assessments for updated future time periods.

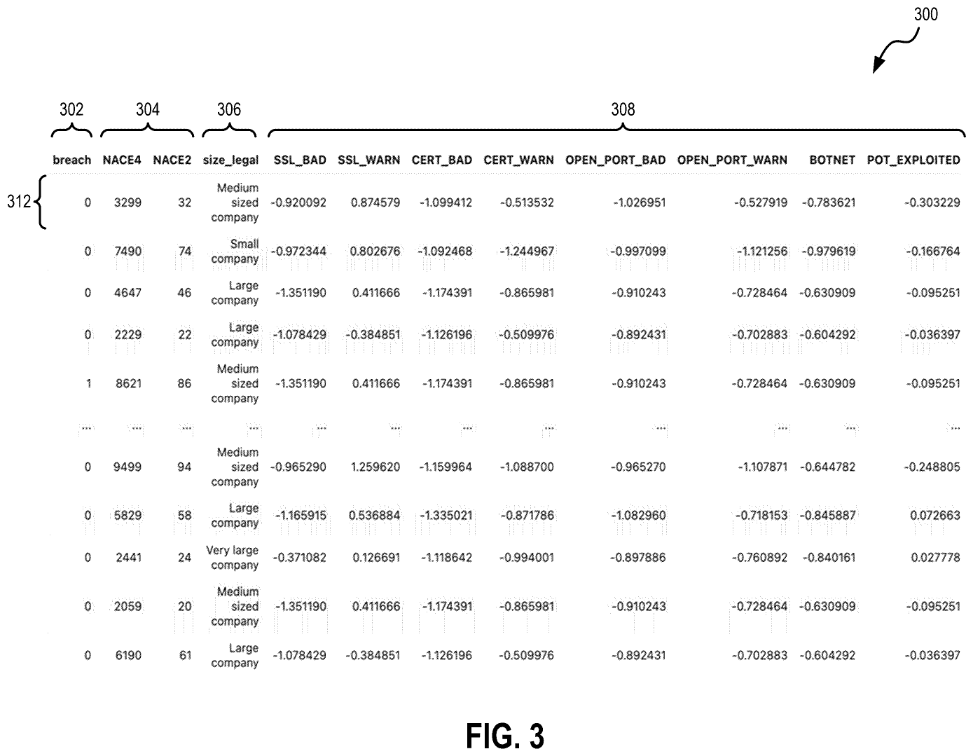

Step 102 of the method 100 may include generating a training dataset 110 including a number of firmographic parameter values 112 for the entities, and a number of aggregated risk feature values 114, and a number of breach indicator values 116 for a number of entities. Each of the entities may be mapped to a respective (e.g., individual) breach indicator value 116 of the breach indicator values 116, where a breach indicator value 116 indicates whether the entity has or has not experienced a cybersecurity incident of a particular type and severity level during a particular time period (e.g., within the previous 1-year period of time). Each of the entities may be mapped to a number of firmographic parameter values 112 including a firmographic size parameter value, firmographic industry parameter value, and firmographic location parameter value that are applicable to and representative of the entity. For example, an entity may be mapped to firmographic parameter values 112 identifying the United States, wireless telecommunications activities, and a large entity size as corresponding to the entity, where the entity is headquartered in the United States, conducts business in the wireless telecommunications industry, and has a large entity size as defined by a number of employees and market capitalization. Based on firmographic location parameter values, each of the entities may be mapped to location-level aggregated risk feature values 114 derived from location-level cybersecurity incident data. The training dataset 110 may include a number of records, where each record includes (i) a breach indicator value 116 for a particular entity, (ii) firmographic parameter values(s) 112 of the entity, and (iii) location-level aggregated risk feature values 114 corresponding to the geographic location of the entity as indicated by the firmographic location parameter value of the record. In some cases, each record may include an entity identifier identifying the entity of the record. An example of a training dataset generated via the method 100 is described further with respect at least FIG. 3

In some embodiments, step 104 of the method can include training, using the training dataset 110, a cybersecurity risk assessment model 120 to generate a predictive risk assessment for entities based on the firmographic parameter values 112 associated with the entities. For example, the trained model 120 may be configured to generate a predictive risk assessment for a particular entity of the entities based on a subset of the firmographic parameter values 112 associated with the entity. Additional features of training the model 120 are described further herein.

In some embodiments, to generate the training dataset 110 as a part of step 102 of the method 100, the method 100 may perform a number of additional steps. The method 100 may include obtaining an entity-level dataset including records for a number of cybersecurity incidents. Each record included in the dataset may exist for a particular (e.g., one) cybersecurity incident and may include metadata identifying a date of the cybersecurity incident, a severity level (e.g., a categorical and/or quantitative severity level) of the cybersecurity incident, and a type of the cybersecurity incident. Some non-limiting examples of types of cybersecurity incidents (e.g., of the entity-level dataset) can include social engineering, ransomware, unsecured database, phishing, and intrusion incidents. For example, a record may include a numerical severity level and social engineering type of cybersecurity incident. Each record may include an entity identifier that identifies a particular entity that experienced the cybersecurity incident identified by the respective record. The entity-level dataset may include records including entity identifiers corresponding to a number of different entities. In some cases, data for the cybersecurity incidents included in the entity-level dataset can be collected using various cybersecurity monitoring systems as described in U.S. patent application Ser. Nos. 13/240,572, 14/021,585, 15/142,677, 16/514,771, and 16/802,232, each of which are incorporated herein by reference in their entireties.

In some embodiments, to generate the training dataset 110, the method 100 may generate, based on the entity-level dataset, a breach dataset including records for a number of breach indicator values 116 mapped to the entities identified by the entity-level dataset. For each entity identified by the entity-level dataset, the method 100 may aggregate each of the records of the entity-level dataset that correspond to (e.g., identify) the entity. Using the aggregated records for the respective entity, the method 100 may identify, for each record of the aggregated records, the date of the cybersecurity incident, the severity level of the cybersecurity incident, and the type of the cybersecurity incident. For the identified date of the record, the method 100 may determine whether the identified date is within a specified period of time. For example, the method 100 may determine whether the date is within a specified 1-year period of time before a present date. For the identified severity level of the record, the method 100 may compare the identified severity level to a threshold severity level. For the identified type of the record, the method 100 may compare the identified type to a number of specified types of cybersecurity incidents. The method 100 may perform the above-described determination and comparison for each of the aggregated records for the respective entity to determine a breach indicator value 116 for the entity. For example, for each record of the aggregated records for the respective entity, the method 100 may determine whether (i) the identified date is within the specified period of time, (ii) the identified severity level is greater than or equal to the threshold severity level, and (iii) the identified type is included within the one or more specified types.

In some embodiments, based on the above-described determination and comparisons for each of the aggregated records for the respective entity, when one or more of the aggregated records for the respective entity has (i) the identified date within the specified period of time, (ii) the identified severity level greater than or equal to the threshold severity level, and (iii) the identified type included within the one or more specified types, the method 100 may determine generate and assign a first breach indicator value 116 (e.g., binary value) to the entity identifier of the respective entity. The first breach indicator value 116 may indicate that the entity has experienced at least one cybersecurity breach within the specified period of time. For example, the method 100 may generate and assign a breach indicator value 116 of 1 mapped to the entity identifier of the entity. Based on the above-described determination and comparisons for each of the aggregated records for the respective entity, when none of the aggregated records for the respective entity has (i) the identified date within the specified period of time, (ii) the identified severity level greater than or equal to the threshold severity level, and (iii) the identified type included within the one or more specified types, the method 100 may generate and assign a second breach indicator value 116 (e.g., binary value) to the entity identifier of the respective entity. The second breach indicator value 116 may indicate that the entity has not experienced at least one cybersecurity breach within the specified period of time. For example, the method 100 may generate and assign a breach indicator value 116 of 0 mapped to the entity identifier of the entity.

In some embodiments, based on the generated breach indicator values 116 the entities identified by the entity-level dataset, the method 100 may include generating the breach dataset including the records for breach indicator values 116 mapped to the entities identified by the entity-level dataset. Each record of the breach dataset may include a breach indicator value 116, an entity identifier of the entity for which the breach indicator value 116 was determined, and the specified period of time for which the breach indicator value 116 is valid. For example, the breach dataset may be a rectangular dataset including a number of records, where each record includes an entity identifier, a breach indicator value 116, and a period of time. An entity of the entities identified by the entity-level dataset may only be identified by one record of the breach dataset, such that a particular entity is not identified by more than one of the records of the breach dataset. Accordingly, the breach dataset may provide insights into individual entities that have experienced a cybersecurity breach having a particular type and severity level within a specified period of time.

In some embodiments, to generate the training dataset 110, the method 100 may include joining (e.g., mapping, enriching, etc.) records of the breach dataset to firmographic parameter values 112 based on the characteristics of the entities identified in the records. A firmographic parameter dataset may include a number of records, where each record includes an entity identifier of an entity and one or more firmographic parameter values 112 corresponding to the entity. The one or more firmographic parameter values 112 may include those described herein, such as a firmographic size parameter value, a firmographic industry parameter value, and a firmographic location parameter value. The method 100 may join the firmographic parameter values 112 of the firmographic parameter dataset to the breach dataset based on common entity identifiers of the datasets to produce a combined breach dataset. Each record of the combined breach dataset may include a breach indicator value 116, an entity identifier of the entity for which the breach indicator value 116 was determined, the specified period of time for which the breach indicator value 116 is applicable (e.g., valid), and the one or more firmographic parameter values 112 for the entity. The combined breach dataset may provide insights into individual entities that have experienced a cybersecurity breach having a particular type and severity level within a specified period of time, along with their respective firmographic parameter values 112.

In some embodiments, to generate the training dataset 110, the method 100 may include obtaining a location-level dataset including records for a number of cybersecurity observations. Each record included in the location-level dataset may exist for a particular (e.g., one) cybersecurity observation and may include metadata identifying a date of the cybersecurity observation, a location (e.g., country) associated with the cybersecurity observation, and a type of the cybersecurity observation. For example, a record may include a country and/or region of a country in which an entity experienced the cybersecurity observation and/or in which the cybersecurity observation occurred. In some cases, each record of the location-level dataset may include an entity identifier that identifies a particular entity that experienced the cybersecurity observation identified by the respective record and/or an industry code identifying an industry associated with the entity that experienced the cybersecurity observation. Exemplary techniques for mapping internet assets to entities are described in U.S. patent application Ser. No. 16/583,991, which is incorporated herein by reference in its entirety. In some cases, some non-limiting examples of types of the cybersecurity observations (e.g., of the location-level dataset) can include:
a number of botnet infection instances of a computer system;
a severity of botnet infection instances of a computer system;
a number of potentially exploited computing devices of a computer system;
an assessment (e.g., categorical assessment) of a Secure Sockets Layer (SSL) certificate and/or a Transport Layer Security (TLS) certificate;
a number of SSL certificates and/or a TLS certificates having an assessment (e.g., categorical assessment) of a particular type (e.g., a ‘bad’ type and a ‘warning’ type)
an assessment (e.g., categorical assessment) of an SSL configuration and/or a TLS configuration;
a number of SSL configurations and/or TLS configurations having an assessment (e.g., categorical assessment) of a particular type (e.g., a ‘bad’ type and a ‘warning’ type);
a number and/or a type of service of open ports of a computer network;
a number of open ports of a computer network having an assessment (e.g., categorical assessment) of a particular type (e.g., a ‘bad’ type and a ‘warning’ type);
a number of spambots of a computer system;
a number of malware servers of a computer system;
a number of unsolicited communications from a host associated with a computer system;
an assessment of application (e.g., web application) security;
an assessment of an unsecured computer system;
a patching cadence for software operating on a computer system;
an assessment of updates to software operating on a computer system; and
an assessment of one or more DomainKeys Identified Mail (DKIM) records.

In some embodiments, one or more of the above-described types of cybersecurity observations may be determined and/or derived from one or more records of the location-level dataset. In some cases types for SSL and/or TLS certificates, SSL and/or TLS configurations, and open ports as described herein may be determined and assigned (e.g., manually or automatically by a security ratings system) via assessment of SSL and/or TLS certificates, SSL and/or TLS configurations, and open ports according to one or more defined criteria. As an example, a first SSL certificate may be assessed and assigned a ‘bad’ type based on the certificate being expired, while a second SSL certificate may be assessed and assigned a ‘warning’ type based on using a Rivest-Shamir-Adleman (RSA) encryption key that is less than 2048 bits. In some cases, computing systems and/or computing assets for one or more of the above-described types of the cybersecurity observations can be computing systems and/or computing assets of entities that are assessed as a part of the methods described herein.

In some embodiments, additionally or alternatively, cybersecurity observations of the location-level dataset can include one or more publicly known information-security vulnerabilities and exposures. In some cases, the publicly known information-security vulnerabilities and exposures can include one or more types of Common Vulnerabilities and Exposures (CVEs) as defined by the National Cybersecurity federally funded research and development center (FFRDC). Types of CVEs may be defined based on a standardized CVE identifier of each CVE. In some cases, records of the location-level dataset may include numbers of one or more particular types of CVEs associated with a computing system. For example, a record of the location-level dataset may identify and correspond to a server (e.g., CVE-2022-41040) vulnerability for a particular location (e.g., country) and at a particular date. An industry standard for assessing the severity of CVEs, such as a Common Vulnerability Scoring System (CVSS), may be used to quantity and/or assess a severity of CVEs.

In some embodiments, each record included in the location-level dataset may include a location identifier (e.g., such as a location code described with respect to the firmographic location parameter values) that identifies a particular geographic location in which the cybersecurity observation occurred. The location-level dataset may include records including cybersecurity observations (i) associated with a number of different geographic locations and (ii) having at least two different types. In some cases, data for the cybersecurity observations included in the entity-level dataset can be collected using various cybersecurity monitoring systems as described herein. In some cases, the data of location-level dataset may be collected using external observation techniques of computing assets.

In some embodiments, to generate the training dataset 110, the method 100 may include determining, based on the location-level dataset, a number of aggregated risk feature values 114 for the geographic locations identified by the location-level dataset. For each of the geographic locations, the method 100 may determine a respective aggregated risk feature value for one or more types (e.g., each type) of cybersecurity observations identified in the location-level dataset. To determine the aggregated risk feature values 114 for each of the geographic locations, for each geographic location identified by the location-level dataset, the method 100 may aggregate each of the records of the location-level dataset. In some cases, each geographic location may correspond to aggregated records identifying cybersecurity events of one or more of (e.g., each of) the types described herein. For each geographic location, the method 100 may generate (e.g., calculate), based on a number of cybersecurity observations for the respective geographic location within a specified period of time and identified by the aggregated records, aggregated risk feature values 114 for the types of cybersecurity observations identified by the aggregated records corresponding to the respective geographic location. For example, when the geographic locations are countries and for each country, the method 100 may generate (e.g., calculate), based on a number of cybersecurity observations observed for the respective country within a specified period of time and identified by the aggregated records, aggregated risk feature values 114 for the types of cybersecurity observations identified by the aggregated records corresponding to the respective country.

In some embodiments, for each geographic location and when the location-level dataset includes records identifying at least one type of CVE, the method 100 may generate an aggregated risk feature value 114 for each type of CVE identified by the location-level dataset. In some cases, for each geographic location and when the location-level dataset includes records identifying at least one type of CVE, the method 100 may generate an aggregated risk feature value 114 for one or more types of CVEs identified by the location-level dataset based on one or more conditions. For each geographic location and when the location-level dataset includes records identifying at least one type of CVE, the method 100 may generate an aggregated risk feature value 114 for the at least one type of CVE when the at least one type of CVE has a CVSS greater than or equal to a threshold value. The method 100 may not generate an aggregated risk feature value 114 for the at least one type of CVE when the at least one CVE has a CVSS less than a threshold value. The method 100 may generate an aggregated risk feature value 114 for at least one type of CVE when the at least one type of CVE is identified in a Known Exploited Vulnerability (KEV) database identifying a number of specified types of CVEs. The method 100 may not generate an aggregated risk feature value 114 for the at least one type of CVE when the at least one type of CVE is not identified in the KEV database. A KEV database may be accessible to the one or more computing devices that execute the method 100.

In some embodiments, an aggregated risk feature value 114 may be a continuous numerical value (e.g., a positive value or negative value) and may indicate the geographic location's cybersecurity performance (e.g., relative to other geographic locations) for the cybersecurity observation type for which the value was determined. For example, the continuous, numerical aggregated risk feature value may indicate a relative rate and/or severity at which the country experiences cybersecurity observations of the type for which the aggregated risk feature value was determined relative to other countries. In some cases, an aggregated risk feature value for a geographic location may be normalized based on one or more cybersecurity characteristics of the respective geographic location. For example, the continuous value of the aggregated risk feature for a geographic location may be normalized based on an internet density of the geographic location to account for differences between internet densities of different geographic locations and enable comparison of aggregated risk feature values 114 across different geographic locations for which aggregated risk feature values 114 are determined. Some non-limiting examples of cybersecurity characteristics of a geographic location that can be used to normalize an aggregated risk feature value can include an internet density (e.g., density of internet availability, density of computing devices connected to the internet, density of internet users, etc.) of the geographic location, a number of internet users of the geographic location, risk vectors aggregated for the geographic location, and numbers (e.g., counts) of one or more types of cybersecurity observations of the geographic location. As an example, an aggregated risk feature value for a particular type of CVE may be normalized based on a total number of the type of CVE identified for the geographic location, such as a number of CVE-2022-41040 server vulnerabilities identified in a country. Risk vector ratings for a geographic location may be determined as described herein.

In some embodiments, while the method 100 is described herein as generating aggregated risk feature values 114 for the geographic locations identified by the location-level dataset, the method 100 may additionally or alternatively generate aggregated risk feature values 114 for firmographic parameters other than a geographic location and/or for combinations of two or more firmographic parameters based on data included in the location-level dataset. In some cases, the method may generate aggregated risk feature values 114 for combinations of individual geographic locations and industries. To determine the aggregated risk feature values 114 for each combination of the geographic locations and industries, for each geographic location and industry identified by the location-level dataset, the method 100 may aggregate each of the records of the location-level dataset. In some cases, each combination of a geographic location and industry may correspond to aggregated records identifying cybersecurity observations of one or more of (e.g., each of) the types described herein. For each combination of a geographic location and industry, the method 100 may generate (e.g., calculate), based on a number of cybersecurity observations for the respective geographic location and industry within a specified period of time and identified by the aggregated records, aggregated risk feature values 114 for the types of cybersecurity observations identified by the aggregated records corresponding to the respective geographic location and industry. For example, when the geographic locations are countries, the industries are identified by NACE codes, and for each combination of a country and NACE code, the method 100 may generate (e.g., calculate), based on a number of cybersecurity observations observed for the respective country and NACE code within a specified period of time and identified by the aggregated records, aggregated risk feature values 114 for the types of cybersecurity observations identified by the aggregated records corresponding to the respective country and NACE code.

In some embodiments, an aggregated risk feature value 114 may be a continuous numerical value (e.g., a positive value or negative value) and may indicate the combination's cybersecurity performance (e.g., relative to other combinations of geographic locations and industries) for the cybersecurity observation type for which the value was determined. For example, the continuous, numerical aggregated risk feature value may indicate a relative rate and/or severity at which the industry and in the country experiences cybersecurity events of the type for which the aggregated risk feature value was determined relative to other combinations of industries and countries. In some cases, an aggregated risk feature value for a combination of a geographic location and industry may be normalized based on one or more cybersecurity characteristics of the respective geographic location and industry. For example, the continuous aggregated risk feature value for a number of SSL certificates having a ‘bad’ type for particular geographic location and industry may be normalized based on a total number of SSL certificate records obtained for the geographic location and the industry to account for differences between SSL certificate records across different combinations of geographic locations and industries and enable comparison of aggregated risk feature values 114 across different combinations of geographic locations and industries for which aggregated risk feature values 114 are determined. Some non-limiting examples of cybersecurity characteristics of a geographic location and industry that can be used to normalize an aggregated risk feature value can include an internet density (e.g., density of internet availability, density of computing devices connected to the internet, density of internet users, etc.) of the geographic location and industry, a number of internet users of the geographic location and industry, risk vectors aggregated for the geographic location and industry, and numbers (e.g., counts) of one or more types of cybersecurity observations of the geographic location and industry. As an example, an aggregated risk feature value for a particular type of CVE may be normalized based on a total number of the type of CVE identified for the geographic location within the industry, such as a number of CVE-2022-41040 server vulnerabilities identified in a country and an industry of television programming and broadcasting activities. Risk vector ratings for a geographic location may be determined as described herein.

In some embodiments, while the method 100 is described herein as normalizing risk feature values 114 based on cybersecurity characteristics of a geographic location and an industry corresponding to the risk feature values 114, the method 100 may additionally or alternatively normalize aggregated risk feature values 114 for firmographic parameters other than a geographic location and/or for combinations of two or more firmographic parameters.

In some embodiments, based on determining the aggregated risk feature values 114 for the geographic locations identified by the location-level dataset, the method 100 may form a feature dataset including a number of records, where each record may include a location identifier identifying a geographic location, one or more determined aggregated risk feature values 114 for the geographic location, and a specified period of time for which the determined values are valid. A particular geographic location of the feature dataset may only be identified by one record of the feature dataset, such that a particular geographic location is not identified by more than one of the records of the feature dataset. Accordingly, the feature dataset may provide insights into aggregated risk feature values 114 for individual geographic locations. Each record may include aggregated risk feature values 114 corresponding to the same types of cybersecurity observations as derived from the location-level dataset.

In some embodiments, based on determining the aggregated risk feature values 114 for the combinations of individual geographic locations and industries identified by the location-level dataset, the method 100 may form a feature dataset including a number of records, where each record may include a location identifier identifying a geographic location, an industry code identifying an industry, one or more determined aggregated risk feature values 114 for the geographic location and industry, and a specified period of time for which the determined values are valid. A particular combination of a geographic location and industry of the feature dataset may only be identified by one record of the feature dataset, such that a particular combination of a geographic location and industry is not identified by more than one of the records of the feature dataset. Accordingly, the feature dataset may provide insights into aggregated risk feature values 114 for combinations of individual geographic locations and industries.

In some embodiments, to generate the training dataset 110, the method 100 may include joining (e.g., mapping, enriching, etc.), based on the geographic locations indicated by the firmographic location parameter values and the location identifiers, the records of the combined breach dataset to the records of the feature dataset to form the training dataset 110. The method 100 may join the combined breach dataset to the feature dataset based on common identifiers of geographic locations. The method 100 may join the combined breach dataset to the feature dataset based on common firmographic parameter values (e.g., geographic locations and industry codes). Each record of the training dataset 110 may include a breach indicator value 116, one or more firmographic parameter values 112 for the entity for which the breach indicator value 116 was determined, one or more determined aggregated risk feature values 114 for the geographic location identified by a firmographic location parameter value of the firmographic parameter values 112, and a specified period of time for which the determined feature values and the breach indicator value 116 are valid. The one or more firmographic parameter values 112 for the entity for which the breach indicator value 116 was determined and the one or more determined aggregated risk feature values 114 (e.g., for the geographic location and/or industry) corresponding to a firmographic location parameter value of the firmographic parameter values 112 of the training dataset 110 may be used as input features for training a model 120 to predict a breach indicator value 116, such that the prediction of the breach indicator value 116 identifies a likelihood an entity will experience a cybersecurity incident during a future time period. The future time period may have a duration equivalent to a duration of a specified period of time for which the determined risk feature values 114 and the breach indicator value 116 are applicable (e.g., valid) as described herein.

In some embodiments, to train a cybersecurity risk assessment model 120 as a part of step 104 of the method 100, the method 100 may perform a number of additional steps. Using the training dataset 110 obtained as a part of step 102 of the method 100, the method may apply one or more statistical modeling techniques and/or machine learning techniques (e.g., a supervised-learning machine learning technique) to train the model 120. In some cases, the model 120 may use one or more statistical modeling techniques and/or machine learning techniques to predict a breach indicator value 116. The method 100 may train the model 120 to predict a breach indicator value 116 for a particular entity based on the firmographic parameter values 112 of the entity and the aggregated risk feature values 114 corresponding to the firmographic parameter value(s) of the entity. Some non-limiting examples of the statistical modeling techniques and/or machine learning techniques used can include a classical logistic regression technique, a hierarchical mixed-effect logistic regression technique, a deep neural network binary classification technique, a Bayesian statistical hierarchical technique, and a gradient boosted decision tree binary classification technique. In some cases, when the model 120 uses a gradient boosted decision tree binary classification technique to generate predictive risk assessments, the model 120 may use nested random effects as features that can predict a breach indicator value. In some cases, a model 120 may include two or more internal models that form an ensemble, where a first internal model of the internal models uses a statistical modeling technique and a second internal model uses a machine learning modeling technique. Use of an ensemble of modeling techniques by the model 120 may improve predictive accuracy of the model 120 to predict a breach indicator value.

In some embodiments, the breach indicator value 116 may operate as a Bernoulli response variable for prediction by the model 120. The model 120 may be trained to receive the firmographic parameter values 112 and the aggregated risk feature values 114 of the training data. The method 100 may include tuning one or more hyperparameters of the model 120 to optimize prediction of a breach indicator value. In some cases, hyperparameters of the model 120 may be tuned based on exemplary outcomes of the training dataset 110, where breach indicator values 116 are first or second values and correspond to the firmographic parameter values 112 and the aggregated risk feature values 114 in their respective records. In some cases, hyperparameters of the model 120 may be tuned based on an architecture (e.g., statistical and/or machine learning modeling techniques) of the model 120 and regularization of the model 120. In some cases, training the model 120 may include minimizing a loss function (e.g., a logarithmic loss function) to estimate free parameters of the model 120. An example of a logarithmic loss function used for training the model 120 is described by Equation 1 as follows:

$$- \frac{1}{N} {\sum }_{i = 1}^{N} ( {y}_{i} log ( {p}_{i} ) + ( 1 - {y}_{i} ) ( log ( 1 - {p}_{i} ) ) \qquad ( 1 )$$

As described in Equation 1, N may refer to a number of observations (e.g., records of the training dataset 110), yᵢ may refer to the actual binary outcome (e.g., a 0 or 1 for the breach indicator value 116) for the i^{th} observation of the number of observations, and pᵢ may refer to the predicted probability that the i^{th} observation has an outcome (e.g., breach indicator value 116) of a 1.

In some cases, for training the model 120, a relationship between the aggregated risk feature values 114 of the training dataset 110 and a predicted breach indicator value may be selected to be monotonically increasing. For example, during training, the model 120 may be tuned to interpret the aggregated risk feature values 114 as monotonically increasing with a likelihood that an entity experiences a cybersecurity incident during a time period (e.g., future time period). Such tuning can effectively reduce a number of free parameters of the model 120 and reducing the potential for overfitting the model 120 to the training dataset 110.

In some embodiments, when the model 120 uses a gradient boosted decision tree algorithm, hyperparameters of the model 120 can include properties that control the shape of the algorithm's decision trees (e.g., a maximum depth and a maximum number of leaves) and parameters to control techniques for regularization and other aspects of the model training algorithm. In an example, for training of the gradient boosted decision tree-based model, the method 100 may select a number of hyperparameters for tuning and may propose a grid of multiple candidate values for each hyperparameter. Such a grid can include a number of combinations from which a subset of combinations can be randomly selected by the method 100. For each selected combination, the method 100 may quantify the out-of-sample predictive performance of the gradient boosted tree-based model by calculating model skill scores, such as area under the receiver operating characteristic curve (AUC) in a five-fold cross validation scheme. The method 100 may determine the combination of hyperparameter values having the highest performance model skill score (e.g., AUC), fix the combination of the hyperparameter values for the model 120, and then retrain the model 120 using the training dataset 110.

In some embodiments, as described herein, the trained model 120 may be configured to generate a predictive cybersecurity risk assessment for an entity based on one or more firmographic parameter values 112 for the entity and the one or more aggregated risk feature values 114 for the geographic location identified by a firmographic location parameter value of the firmographic parameter values 112. In some cases, the predictive cybersecurity risk assessment can include a probabilistic assessment of a likelihood that the entity experiences a cybersecurity incident during a future time period. The probabilistic assessment may include a prediction of a breach indicator value 116 for the entity, which indicates whether or not the entity is expected to experience at least one cybersecurity incident (e.g., having a particular type and severity level) during a future time period. In some cases, the probabilistic assessment may include a numerical probability the entity is expected to experience at least one cybersecurity incident (e.g., having a particular type and severity level) during a future time period. Based on the probability, a categorical assessment may be provided to indicate the numerical probability in natural language terms. For example, the categorical assessments may include a very low risk, a low risk, a medium risk, a high risk, and a very high risk of experiencing at least one cybersecurity incident during a future time period.

FIG. 3 is a diagram of a training dataset 300 for training a model (e.g., model 120) to generate predictions of a cybersecurity risk for an entity based on the entity's firmographic parameters. The training dataset 300 may be an example of a training dataset (e.g., training dataset 110) generated using the methods (e.g., method 100) described herein. The training dataset may include a number of records 312, where each record 312 includes a breach indicator value 302, a number of firmographic parameter values for an entity, and a number of aggregated risk feature values 308 corresponding to respective cybersecurity observation types. As described herein, a breach indicator value 302 can indicate whether the entity corresponding to the record 312 has or has not experienced a cybersecurity incident of a particular type and severity level during a particular time period (e.g., within the previous 1-year period of time). The firmographic parameter values of a record 312 may include one or more firmographic industry parameter values 304 (e.g., a 4-digit NACE code and a 2-digit NACE codes) and one or more firmographic size parameter values 306. In the example of FIG. 3, the training dataset 300 may include records 312 including aggregated risk feature values 308 aggregated for the country identified by the firmographic location parameter value of the entity corresponding to the respective breach indicator value 302, which include continuous, numerical aggregated risk feature values 308 for cybersecurity observation types including: a number and/or severity of botnet infection instances of a computer system; a number of potentially exploited computing devices of a computer system; a number of SSL certificates having an assessment (e.g., categorical assessment) of a particular type (e.g., a ‘bad’ type and a ‘warning’ type); a number of SSL configurations having an assessment (e.g., categorical assessment) of a particular type (e.g., a ‘bad’ type and a ‘warning’ type); and a number of open ports of a computer network having an assessment (e.g., categorical assessment) of a particular type (e.g., a ‘bad’ type and a ‘warning’ type).

### Some Embodiments of Generating Cybersecurity Risk Predictions

In some exemplary methods described herein, a trained model can be used to generate a probabilistic assessment of a likelihood that an entity experiences a cybersecurity incident during a particular time period (e.g., a future time period) based on firmographic parameter values of the entity. To generate, by a trained model, a probabilistic assessment of a likelihood that an entity experiences a cybersecurity incident during a particular time period, the methods described herein may perform steps including: (1) obtaining a number of firmographic parameter values of the entity, and (2) generating, by the trained model using the firmographic parameter values of the entity, a probabilistic assessment of a likelihood that an entity experiences a cybersecurity incident during a particular time period

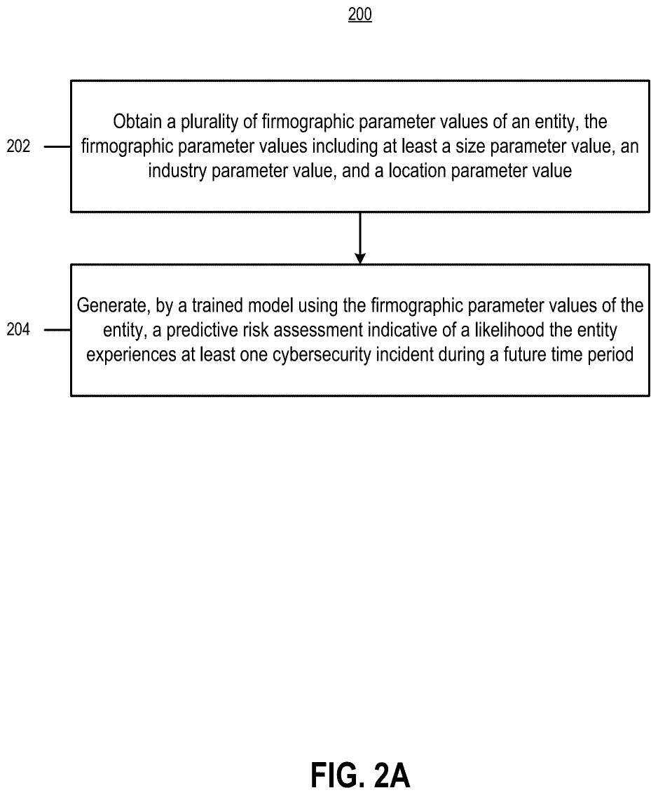

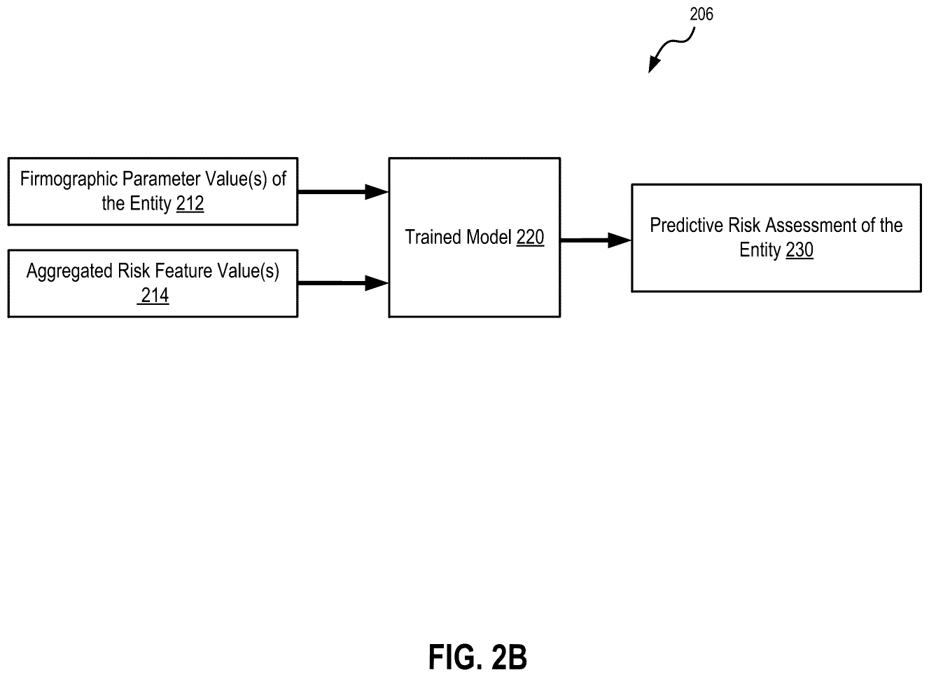

FIG. 2A is a flowchart illustrating a method 200 for generating a prediction of a cybersecurity risk for an entity based on the entity's firmographic parameters. FIG. 2B is a diagram of the workflow 206 a prediction of a cybersecurity risk for an entity based on the entity's firmographic parameters. The prediction may include probabilistic assessments of a likelihood that an entity experiences a cybersecurity incident during a particular time period, such as a future time period. One of ordinary skill in the art will appreciate that the method 200 may be executed more than once to generate multiple predictions for multiple combinations of firmographic parameter values and for multiple trained models (e.g., based on updates to the training datasets and/or desirable outputs provided by the models). For example, the method 200 may be re-executed to generate predictions for different combinations of firmographic parameter values.

In some embodiments, step 202 of the method 200 may include obtaining one or more firmographic parameter values 212 of an entity. The entity may be mapped to a number of firmographic parameter values 212 including a firmographic size parameter value, firmographic industry parameter value, and firmographic location parameter value that are applicable to and representative of the entity as described herein. For example, an entity may be mapped to firmographic parameter values 212 identifying the United States, wireless telecommunications activities, and a large entity size as corresponding to the entity, where the entity is headquartered in the United States, conducts business in the wireless telecommunications industry, and has a large entity size as defined by a number of employees and market capitalization.

In some embodiments, step 202 of the method can include obtaining location-level aggregated risk feature values 214, where the aggregated risk feature values 214 correspond to the geographic location of the entity as indicated by the firmographic location parameter value of the entity included in the firmographic parameter values 212.

In some embodiments, step 204 of the method can generate, by a trained model 220 using the firmographic parameter values 212 of the entity and the aggregated risk feature values 214, a predictive risk assessment 230 indicative of a likelihood the entity experiences at least one cybersecurity incident during a time period (e.g., future time period). The trained model 220 may be trained as described herein (e.g., with respect to the method 100) and may use one or more statistical modeling techniques and/or machine learning techniques to generate the predictive risk assessment 230. Some non-limiting examples of the statistical modeling techniques and/or machine learning techniques used can include a classical logistic regression technique, a hierarchical mixed-effect logistic regression technique, a deep neural network binary classification technique, a Bayesian statistical hierarchical technique, and a gradient boosted decision tree binary classification technique. The predictive risk assessment 230 may include a probabilistic assessment of a likelihood that an entity experiences at least one cybersecurity incident during a particular time period. In some cases, the predictive risk assessment 230 may include a numerical probability (e.g., a value of 0%-100%, a value of 0-1, a value of 0-100, etc.) and/or categorical assessment (e.g., a grade or categorical rating) of a likelihood that an entity experiences a cybersecurity incident during a particular time period. For example, the categorical assessments may include a very low risk, a low risk, a medium risk, a high risk, and a very high risk of experiencing at least one cybersecurity incident during a future time period. In some cases, the predictive risk assessment 230 may include a probabilistic assessment that entity is expected to experience at least one cybersecurity incident having (i) particular type of one or more specified types and/or (ii) a severity level greater than or equal to a threshold severity level during a time period.

In some embodiments, the particular time period for which the predictive risk assessment 230 is applicable to the entity may (i) have a particular duration and (ii) be defined from a particular starting date and/or time to a particular ending date and/or time. In some cases, a duration of the time period for which the predictive risk assessment 230 is applicable to the entity may be less than, equal to, or greater than a duration of time for which breach indicator values are determined as being applicable to entity as described herein for the trained model 220 (e.g., with respect to the method 100). For example, when a training dataset 110 used to train the model 220 includes breach indicator values that are applicable to an entity for a 1-year period (e.g., such that the entity experienced a cybersecurity incident having a specified type and severity level during the 1-year time period), the predictive risk assessment 230 generated by the model 220 may include a probabilistic assessment of a likelihood that an entity experiences at least one cybersecurity incident during a 1-year time period starting at a first, earlier date and ending at a second, later date. In some cases, the particular time period to which the predictive risk assessment 230 applies may be a future time period, such that the predictive risk assessment 230 provides a prediction of future cybersecurity incidents that may be experienced by an entity.

### Risk Vectors of Entities

In some embodiments, determining cybersecurity security risk of entities associated with geographic locations can use externally observable information as proxies for (i) the effectiveness of the overall security performance of the policies and controls that entities associated with the geographic location (e.g., country) implement and exercise and/or (ii) the vulnerability of the entities of the geographic location to security risk. This externally observable information can be categorized into observable subject areas, or “vectors”, which can each be independently determined and/or characterized. For example, one possible proxy for entity vulnerability is the number of entity-owned IP addresses which are reported by third parties to be malicious. The greater the number of reports, the more likely the particular entity was vulnerable and had been compromised. Examples of subject areas (“vectors”) may include:
an amount of capital investment in the security of the entity;
a measure of employee training in the security of the entity;
a measure of organization of entity personnel dedicated to information security;
an amount of the entity's budget dedicated to information security;
a number and/or severity of botnet infection instances of a computer system associated with the entity;
a number of spam propagation instances originating from a computer network associated with the entity;
a number of malware servers associated with the entity;
a number of potentially exploited devices associated with the entity;
a number of hosts authorized to send emails on behalf of each domain associated with the entity;
a determination of whether a DomainKeys Identified Mail (DKIM) record exists for each domain associated with the entity and/or a key length of a public key associated with a Domain Name System (DNS) record of each domain associated with the entity;
an evaluation of a Secure Sockets Layer (SSL) certificate and/or a Transport Layer Security (TLS) certificate associated with a computer system of the entity;
a number and/or type of service of open ports of a computer network associated with the entity;
an evaluation of security-related fields of a header section of HTTP response messages of hosts associated with the entity;
a rate at which vulnerabilities are patched in a computer network associated with the entity;
an evaluation of file sharing traffic originating from a computer network associated with the entity;
a number of lost records and/or sensitivity of information in the lost records in a data breach of a computer system associated with the entity;
a determination of underwriting, evaluating, and monitoring for cyber insurance of the entity; and/or
an evaluation of an adjustment (e.g., automatic adjustment) of access control policy for specific groups and/or individuals of the entity (e.g., a change in VPN access).

In some embodiments, received data for an entity can include two or more subject areas (e.g., of those listed above). In some embodiments, risk vectors for entities may be aggregated at a location-level (e.g., country level) and/or industry-level based on geographic locations (e.g., identified by location codes) and industries (e.g., identified by industry codes) corresponding to entities. In some cases, ratings can be assigned to individual risk vectors to assess a level of risk of the individual risk vectors to an entity. In some cases, risk vectors and ratings for risk vectors can be determined using various cybersecurity monitoring systems as described in U.S. patent application Ser. Nos. 13/240,572, 15/142,677, 16/514,771, and 16/802,232. One or more of the risk vectors may be used to determine (e.g., normalize) aggregated risk feature values as described herein. In some cases, computing systems and/or computing assets for one or more of the above-described types of the vectors can be computing systems and/or computing assets of entities that are assessed as a part of the methods described herein.

### Computer-Based Implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

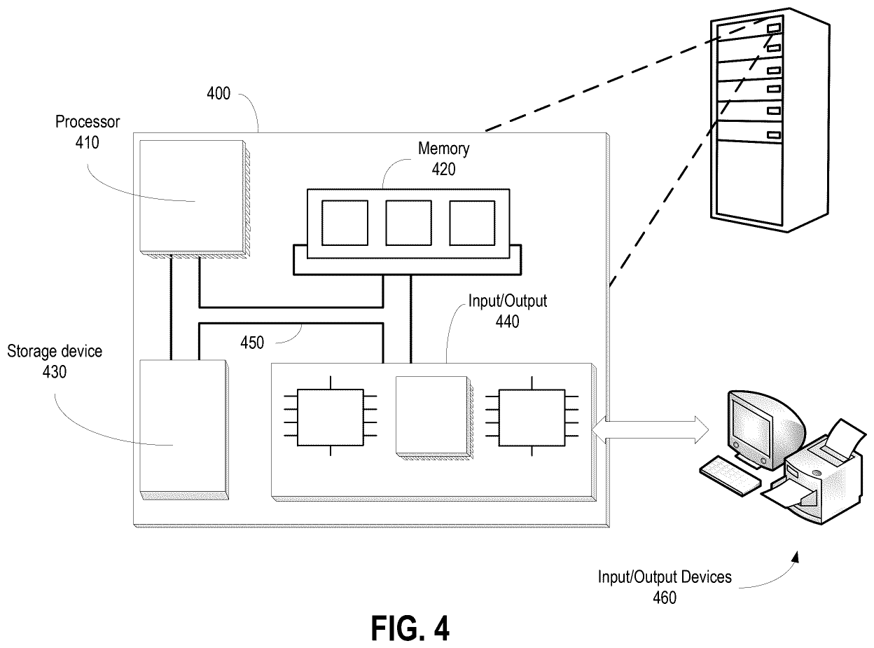

FIG. 4 is a block diagram of an example computer system 400 that may be used in implementing the technology described in this document. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-date drive, a flash drive, or some other large capacity storage device. For example, the storage device may store long-term data (e.g., database data, file system data, etc.). The input/output device 440 provides input/output operations for the system 400. In some implementations, the input/output device 440 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method for training a model to predict a cybersecurity risk based on entity firmographics, the method comprising:
generating, based on a first security incident dataset comprising a plurality of first security incidents, a breach dataset comprising a plurality of breach indicator values for a plurality of entities, wherein each respective breach indicator value is (i) mapped to a respective entity of the entities and (ii) an evaluation of at least one of the first security incidents being associated with the respective entity during a time period;
joining, based on the entities, the breach indicator values of the breach dataset to a plurality of firmographic parameter values corresponding to the entities;
obtaining a second security observation dataset comprising a plurality of second security observations associated with a plurality of geographic locations;
determining, based on the second security observation dataset, a plurality of aggregated risk feature values for the geographic locations, wherein each geographic location is associated with at least one of the aggregated risk feature values;
joining, based on the geographic locations, the aggregated risk feature values to the breach indicator values and the firmographic parameter values to form a training dataset comprising each of (i) the breach indicator values, (ii) the aggregated risk feature values, and (iii) the firmographic parameter values; and
training, using the training dataset, a cybersecurity risk assessment model configured to generate a predictive risk assessment for a first entity of the entities based on a subset of the firmographic parameter values associated with the first entity.

2. The method of claim 1, wherein for each respective first security incident, the first security incident dataset comprises (i) a type of the respective first security incident, (ii) a severity level of the respective first security incident, and (iii) a date associated with the respective first security incident.

3. The method of claim 2, wherein generating the breach dataset is based on the types, the severity levels, and the dates of the first security incidents.

4. The method of claim 2, wherein generating the breach dataset comprises:
for at least one of the first security incidents:
identifying a second entity of the entities associated with the first security incident;
comparing (i) a type of the first security incident to one or more specified types, (ii) a severity level of the first security incident to a threshold severity level, and (iii) a date of the first security incident to the time period; and
generating, based on the comparison, a breach indicator value of the breach indicator values, wherein the breach indicator value is mapped to the second entity.

5. The method of claim 1, wherein the evaluation of at least one of the first security incidents being associated with the respective entity during the time period comprises (i) a first value identifying at least one of the first security incidents as associated with the respective entity during the time period or (ii) a second value identifying none of the first security incidents as associated with the respective entity during the time period.

6. The method of claim 1, wherein the firmographic parameter values comprise one or more of: (i) a plurality of geographic location parameter values, (ii) a plurality of size parameter values, and (iii) a plurality of industry parameter values.

7. The method of claim 6, wherein:
(i) a geographic location parameter value of the geographic location parameter values indicates a geographic location of the geographic locations associated with an entity of the entities;
(ii) a size parameter value of the size parameter values indicates a size of the entity; and
(iii) an industry parameter value of the industry parameter values indicates an industry associated with the entity.

8. The method of claim 6, wherein joining the breach indicator values to the firmographic parameter values comprises:
joining a breach indicator value of the breach indicator values to each of (i) a geographic location parameter value of the geographic location parameter values, (ii) a size parameter value of the size parameter values, and (iii) an industry parameter value of the industry parameter values based on the respective entity associated with the breach indicator value.

9. The method of claim 1, wherein the second security observations comprise at least two security observation types.

10. The method of claim 9, wherein the at least two security observation types comprise at least one of:
a number and/or a severity of botnet infection instances of a computer system;
a number of potentially exploited computing devices;
an evaluation of a Secure Sockets Layer (SSL) certificate and/or a Transport Layer Security (TLS) certificate;
an evaluation of a Secure Sockets Layer (SSL) configuration and/or a Transport Layer Security (TLS) configuration; and
a number and/or a type of service of open ports of a computer network.

11. The method of claim 1, wherein determining the aggregated risk feature values for the geographic locations comprises:
identifying a subset of the second security observations associated with a geographic location of the geographic locations; and
determining at least one of the aggregated risk feature values corresponding to the geographic location by normalizing the subset of the second security observations based on the geographic location.

12. The method of claim 1, wherein at least one of the aggregated risk feature values comprises a continuous numerical value.

13. The method of claim 1, wherein training the cybersecurity risk assessment model comprises applying a machine learning technique to (i) the breach indicator values, (ii) the aggregated risk feature values, and (iii) the firmographic parameter values.

14. The method of claim 13, wherein the machine learning technique comprises at least one of (i) a deep neural network binary classification technique and (ii) a gradient boosted decision tree algorithm.

15. The method of claim 1, wherein training the cybersecurity risk assessment model comprises applying a statistical technique to (i) the breach indicator values, (ii) the aggregated risk feature values, and (iii) the firmographic parameter values.

16. The method of claim 15, wherein the statistical technique comprises at least one of (i) a classical logistic regression technique, (ii) a hierarchical mixed-effect logistic regression technique, and (iii) a Bayesian statistical hierarchical technique.

17. The method of claim 1, further comprising:
generating, by the cybersecurity risk assessment model, the predictive risk assessment for the first entity of the entities based on the subset of the firmographic parameter values associated with the first entity, wherein the predictive risk assessment is indicative of a future security incident being associated with the first entity during a future time period.

18. The method of claim 17, wherein the cybersecurity risk assessment model is configured to generate a probability of the future security incident being associated with the first entity during the future time period, wherein the predictive risk assessment comprises the probability.

19. The method of claim 17, wherein the cybersecurity risk assessment model is configured to generate a categorical assessment of the future security incident being associated with the first entity during the future time period, wherein the predictive risk assessment comprises the categorical assessment.

20. The method of claim 17, wherein a duration of the time period is equivalent to a duration of the future time period.

21. A system for training a model to predict a cybersecurity risk based on entity firmographics, the system comprising:
one or more computing systems programmed to perform operations comprising:
generating, based on a first security incident dataset comprising a plurality of first security incidents, a breach dataset comprising a plurality of breach indicator values for a plurality of entities, wherein each respective breach indicator value is (i) mapped to a respective entity of the entities and (ii) an evaluation of at least one of the first security incidents being associated with the respective entity during a time period;
joining, based on the entities, the breach indicator values of the breach dataset to a plurality of firmographic parameter values corresponding to the entities;
obtaining a second security observation dataset comprising a plurality of second security observations associated with a plurality of geographic locations;
determining, based on the second security observation dataset, a plurality of aggregated risk feature values for the geographic locations, wherein each geographic location is associated with at least one of the aggregated risk feature values;
joining, based on the geographic locations, the aggregated risk feature values to the breach indicator values and the firmographic parameter values to form a training dataset comprising each of (i) the breach indicator values, (ii) the aggregated risk feature values, and (iii) the firmographic parameter values; and
training, using the training dataset, a cybersecurity risk assessment model configured to generate a predictive risk assessment for a first entity of the entities based on a subset of the firmographic parameter values associated with the first entity.
